(19) United States
(12) Patent Application Publication
(10) Pub. No.: US 2026/0196626 A1
(43) Pub. Date: Jul. 9, 2026

(54) SEALER FOR SECONDARY BATTERY AND SECONDARY BATTERY INCLUDING SEALER

(71) Applicant: SAMSUNG SDI CO., LTD., Yongin-si (KR)

(72) Inventors: Hiroshi SEINO, Yongin-si (KR); Jeongchull AHN, Yongin-si (KR); Sanghyun KIM, Yongin-si (KR); Daesik KIM, Yongin-si (KR)

(21) Appl. No.: 19/341,810

(22) Filed: Sep. 26, 2025

(30) Foreign Application Priority Data
Jan. 9, 2025 (KR) 10-2025-0003497

(51) Int. Cl. H01M 50/195; H01M 50/186; H01M 50/655

(52) U.S. Cl. CPC H01M 50/195; H01M 50/186; H01M 50/655

(57) ABSTRACT

A sealer for a secondary battery may seal a through-hole formed in a case of the secondary battery and may include a self-restoring material. A secondary battery may include an electrode assembly, a case configured to accommodate the electrode assembly, and the sealer, having the self-restoring material, sealing the through-hole. The case may have a through-hole formed on at least one surface of the case to allow fluid injection or discharge.

### CROSS-REFERENCE TO RELATED APPLICATION

The present application claims priority to and the benefit of Korean Application No. 10-2025-0003497, filed on Jan. 9, 2025, in the Korean Intellectual Property Office, the entire disclosure of which is incorporated by reference herein.

### BACKGROUND

### Field

The present disclosure relates to a sealer for a secondary battery and to a secondary battery including the sealer.

### Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and are widely used for storing power (e.g., home and/or utility scale power storage). A secondary battery generally includes an electrode assembly composed of a positive electrode and a negative electrode, a case accommodating the electrode assembly, and electrode terminals connected to the electrode assembly.

When the secondary battery is charged and/or discharged, gas may be generated inside the secondary battery. When the gas is generated, the gas, which is internal to the case, may cause deformation of the electrode assembly, and such deformation may induce a short circuit inside the electrode assembly. Accordingly, it is necessary to discharge the gas, as the generation of the gas may lower the safety of the secondary battery.

The above information disclosed in this Background section is for enhancement of understanding of the background of the present disclosure, and therefore, it may contain information that does not constitute related (or prior) art.

### SUMMARY

The present disclosure provides a sealer for a secondary battery and a secondary battery including the sealer to solve the above technical problem.

These and other aspects and features of the present disclosure will be described in or will be apparent from the following description of some embodiments of the present disclosure.

An assembly for a secondary battery according to some embodiments of the present disclosure may include a case and a sealer including a self-restoring material. The sealer seals a through-hole formed in the case.

In some embodiments, the self-restoring material may have a viscosity allowing a movement of molecules contained in the self-restoring material such that a deformed geometry of the sealer recovers after a gas generated inside the case passes through the sealer.

In some embodiments, the self-restoring material may include isotactic polypropylene, polyvinyl chloride, polyurethane, polyrotaxane, polyester, epoxy resin, or acrylic ester.

In some embodiments, the sealer may further include a porous film having a mesh structure.

In some embodiments, a portion of the self-restoring material may be located within an internal pore of the porous film.

In some embodiments, the sealer may further include an inorganic filler that may be heat-resistant.

In some embodiments, the sealer may further include a low-water-vapor permeability resin that reduces an amount of the gas flowing through the sealer.

A secondary battery according to some embodiments of the present disclosure may include an electrode assembly; a case accommodating the electrode assembly, the case having a through-hole on a surface of the case to allow fluid injection or discharge; and a sealer. The sealer may include a self-restoring material. The sealer seals the through-hole of the case.

In some embodiments, the through-hole of the case may include an electrolyte injection port accepting an electrolyte to flow into the case.

In some embodiments, the through-hole of the case may include a vent discharging gas from an inside of the case to an outside of the case.

In some embodiments, the sealer seals the through-hole of the case by covering the through-hole of the case from an inner side of the case.

In some embodiments, the sealer seals the through-hole of the case by covering the through-hole of the case from an outer side of the case.

In some embodiments, an area of a geometry of the sealer may be greater than an area of a geometry of the through-hole of the case.

In some embodiments, the secondary battery may further include a first adhesive layer positioned between the case and the sealer.

In some embodiments, the first adhesive layer may include a through-portion penetrating a central region of the first adhesive layer. A diameter of the through-portion of the first adhesive layer may be greater than a diameter of the through-hole of the case.

In some embodiments, the secondary battery may further include a rivet portion penetrating the sealer and being inserted into the through-hole of the case.

In some embodiments, the secondary battery may further include a second adhesive layer positioned between the rivet portion and the sealer.

In some embodiments, the self-restoring material may include isotactic polypropylene, polyvinyl chloride, polyurethane, polyrotaxane, polyester, epoxy resin, or acrylic ester.

In some embodiments, the sealer may further include a porous film having a mesh structure.

A secondary battery according to some embodiments of the present disclosure may include an electrode assembly; a case accommodating the electrode assembly, the case having a through-hole formed on a surface of the case to discharge gas from an inside of the case to an outside of the case; and a sealer sealing the through-hole of the case. The sealer may include a self-restoring material including isotactic polypropylene, polyvinyl chloride, polyurethane, polyrotaxane, polyester, epoxy resin, or acrylic ester and a porous film having a mesh structure. The sealer may further include an inorganic filler that may be heat-resistant or a low-water-vapor permeability resin that reduces an amount of gas flowing through the sealer. The self-restoring material may have a viscosity allowing a movement of molecules contained in the self-restoring material such that a deformed geometry of the sealer recovers after gas generated inside the case passes through the sealer.

In some embodiments, the sealer is configured such that a deformed geometry of the sealer recovers after a gas generated inside the case passes through the sealer.

In some embodiments, the self-restoring material may include isotactic polypropylene, polyvinyl chloride, polyurethane, polyrotaxane, polyester, epoxy resin, or acrylic ester.

In some embodiments, the sealer further may include a porous film having a mesh structure.

In some embodiments, at least a portion of the self-restoring material is located within an internal pore of the porous film.

In some embodiments, the sealer further may include an inorganic filler that is heat-resistant.

In some embodiments, the sealer further may include a low-water-vapor permeability resin that reduces an amount of the gas flowing through the sealer.

In some embodiments, a secondary battery may include an electrode assembly, a case configured to accommodate the electrode assembly, the case having a through-hole formed on a surface of the case to allow fluid injection or discharge, and a sealer sealing the through-hole of the case. The sealer may include a self-restoring material.

In some embodiments, the through-hole may include an electrolyte injection port configured to accept an electrolyte into the case.

In some embodiments, the through-hole may include a vent configured to discharge gas from an inside of the case to an outside of the case.

In some embodiments, the sealer seals the through-hole of the case by covering the through-hole of the case from an inner side of the case.

In some embodiments, the sealer seals the through-hole of the case by covering the through-hole of the case from an outer side of the case.

In some embodiments, an area of a geometry of the sealer is greater than an area of a geometry of the through-hole.

In some embodiments, the secondary battery may further include a first adhesive layer positioned between the case and the sealer.

In some embodiments, the first adhesive layer may include a through-portion penetrating a central region of the first adhesive layer. A diameter of the through-portion of the first adhesive layer may be greater than a diameter of the through-hole of the case.

In some embodiments, the secondary battery further may include a rivet portion penetrating the sealer and being inserted into the through-hole.

In some embodiments, the secondary battery further may include a second adhesive layer positioned between the rivet portion and the sealer.

In some embodiments, the self-restoring material may include isotactic polypropylene, polyvinyl chloride, polyurethane, polyrotaxane, polyester, epoxy resin, or acrylic ester.

In some embodiments, the sealer further may include a porous film having a mesh structure.

In some embodiments, a secondary battery may include an electrode assembly; a case configured to accommodate the electrode assembly, the case having a through-hole formed on at least one surface of the case to discharge gas from inside the case to the outside; and a sealer sealing the through-hole. The sealer may include a self-restoring material and a porous film having a mesh structure and may further include an inorganic filler having heat-resistant characteristics or a low-water-vapor permeability resin that reduces an amount of gas flowing through the sealer. The self-restoring material may include isotactic polypropylene, polyvinyl chloride, polyurethane, polyrotaxane, polyester, epoxy resin, or acrylic ester. The sealer may be configured such that a deformed geometry of the sealer recovers after gas generated inside the case passes through the sealer.

According to some embodiments of the present disclosure, by sealing the through-hole of the case with the sealer including the self-restoring material, the secondary battery may be reused. Accordingly, even if gas is discharged from the secondary battery that is exposed to a high-temperature and/or a high-pressure environment, the secondary battery may be stabilized. Further, the stabilized secondary battery may be safely reused.

Accordingly, the secondary battery may be recyclable, and, therefore, costs may be reduced, and the environment may benefit.

According to some embodiments of the present disclosure, the sealer may be manufactured to satisfy conditions corresponding to various secondary-battery designs and environments.

However, aspects and features of the present disclosure are not limited to those described above, and other aspects and features not mentioned will be clearly understood by a person skilled in the art from the detailed description, the drawings, and the claims of the present disclosure.

### BRIEF DESCRIPTION OF DRAWINGS

The following drawings attached to this specification illustrate embodiments of the present disclosure, and the drawings further show some aspects and features of the present disclosure together with the detailed description of the present disclosure. However, the present disclosure should not be construed as being limited to the drawings.

FIG. 1 is an exploded perspective view illustrating a secondary battery according to some embodiments of the present disclosure.

FIG. 2 illustrates a secondary battery according to some embodiments of the present disclosure.

FIG. 3 illustrates a partial-area enlargement of a secondary battery according to some embodiments of the present disclosure.

FIG. 4 illustrates a case to which a sealer is coupled according to some embodiments of the present disclosure.

FIG. 5 illustrates a case to which a sealer is coupled according to some embodiments of the present disclosure.

FIG. 6 illustrates a sealer and an adhesive layer according to some embodiments of the present disclosure.

FIG. 7 illustrates a sealer and a rivet portion according to some embodiments of the present disclosure.

FIG. 8 illustrates a sealer and a rivet portion according to some embodiments of the present disclosure.

FIG. 9 illustrates a sealer and a rivet portion according to some embodiments of the present disclosure.

FIG. 10 illustrates a porous film according to some embodiments of the present disclosure.

FIG. 11 illustrates a sealer according to some embodiments of the present disclosure.

FIG. 12 illustrates a process in which gas is discharged through a sealer according to some embodiments of the present disclosure.

FIG. 13 illustrates a sealer and a functional layer according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements and/or layers may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” and “upper,” may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lesser numerical limitations subsumed therein, and any minimum numerical limitation recited in this specification is intended to include all greater numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements and/or features as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes and relative sizes of the layers and regions illustrated in the drawings may be exaggerated for clarity of description. That is, the sizes shown in the drawings are merely for ease of understanding and are not limiting. Throughout the entire specification, the same reference numerals denote the same components.

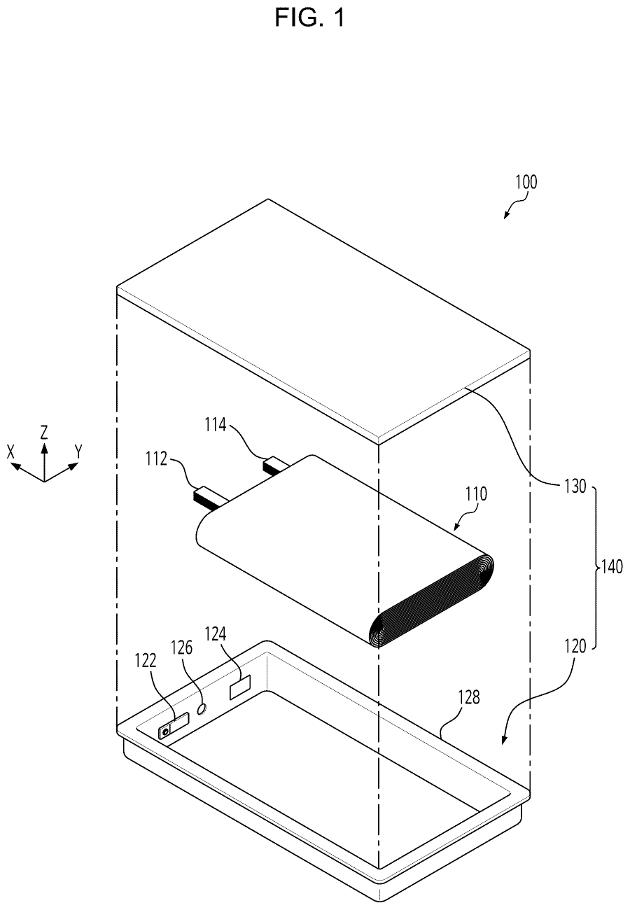

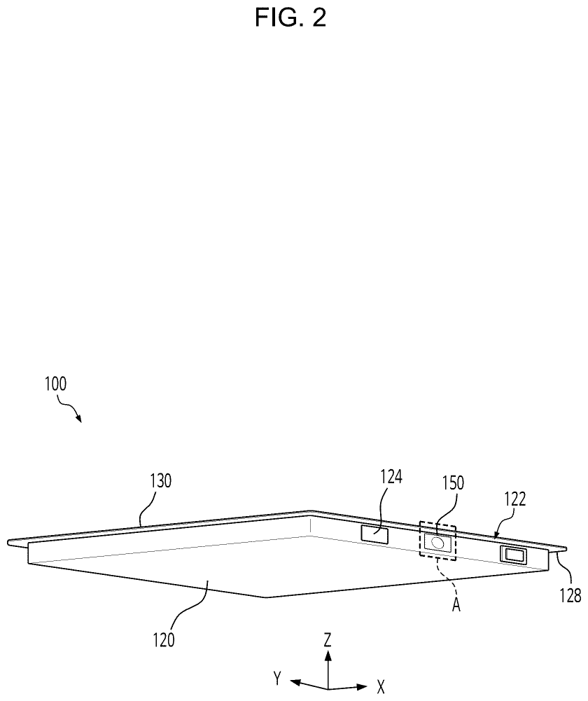

FIG. 1 is an exploded perspective view illustrating a secondary battery 100 according to some embodiments of the present disclosure. FIG. 2 illustrates the secondary battery 100 according to some embodiments of the present disclosure.

The secondary battery 100 may include an electrode assembly 110 that includes a positive electrode, a separator that is an insulator, and a negative electrode, and a case 140 configured to accommodate the electrode assembly 110. The case 140 may include a case body 120 that accommodates the electrode assembly 110 and has one surface (for example, a surface in a Z-direction of the case body 120) open and a cover 130 seated on the open surface of the case body 120 and coupled to the case body 120. For example, the electrode assembly 110 may be wound or stacked while the separator is interposed between the positive electrode and the negative electrode. The case 140 illustrated in FIG. 1 may include stainless steel (SUS), and, therefore, the secondary battery 100 may be a SUS-can-type secondary battery. However, the present disclosure is not limited thereto. For example, the case 140 may be formed of a conductive metal such as aluminum, an aluminum alloy, or nickel-plated steel to form an overall exterior of the secondary battery 100.

A positive-electrode tab 112 may be connected to one side of the positive electrode, and a negative-electrode tab 114 may be connected to one side of the negative electrode in the electrode assembly 110. The positive-electrode tab 112 and the negative-electrode tab 114 may be connected by welding tabs to non-coated portions of the positive electrode and the negative electrode or may be formed by punching the non-coated portions. In the wound state, the positive-electrode tab 112 and the negative-electrode tab 114 may be disposed side by side at a predetermined interval. However, the positive-electrode tab 112 and the negative-electrode tab 114 may also be disposed on different sides of the secondary battery. The electrode assembly 110 may have any structure that includes electrode tabs.

The case 140 may include a positive-terminal 122 and a negative-terminal 124. The positive-terminal 122 may be electrically connected to the positive-electrode tab 112 of the electrode assembly 110, and the negative-terminal 124 may be electrically connected to the negative-electrode tab 114 of the electrode assembly 110. In addition, the positive-terminal 122 and the negative-terminal 124 may be formed on another surface of the case body 120 (for example, a surface in an X-direction of the case body 120). The positions of the positive-terminal 122 and the negative-terminal 124 are not limited to those illustrated in FIG. 1 and may have various modifications.

The case 140 may include a through-hole formed on at least one surface of the case 140. The through-hole may be configured such that fluid (for example, electrolyte and/or gas) is injected or discharged. The through-hole may include an electrolyte injection port 126 configured so that electrolyte is injected into the case 140. In addition, the through-hole may include a vent configured so that gas inside the case 140 is discharged to the outside. In some embodiments, at least one through-hole may be formed in the case 140. An electrolyte injection port 126 may be formed on one surface of the case body 120, and a vent may be formed on the cover 130. In some embodiments, an electrolyte injection port 126 may be formed on one surface of the case body 120, and a vent may be formed on another surface of the case body 120. However, the present disclosure is not limited thereto, and at least one through-hole may be formed at various locations of the case 140.

In some embodiments, the case 140 may include the electrolyte injection port 126. The electrolyte injection port 126 may be a through-hole formed on one surface of the case body 120 (for example, a surface in an X-direction of the case body 120) and may be formed to inject an electrolyte into the inside of the case 140 after the case body 120 and the cover 130 have been joined and sealed. After the electrolyte is injected, the sealer 150 may be coupled to the electrolyte injection port 126. Although the electrolyte injection port 126 is illustrated as being located between the positive-terminal 122 and the negative-terminal 124, the present disclosure is not limited thereto, and various modifications are possible.

In some embodiments, a vent (not illustrated) may be formed on one surface of the case 140. The vent may be configured so that gas inside the case 140 is discharged to the outside. The vent may be configured to open when an internal pressure of the case 140 exceeds a predetermined critical pressure. The critical pressure may be set differently depending on a field of use, material, and/or purpose of the secondary battery 100. In a secondary battery whose average internal pressure is greater than in other fields because a charge-discharge cycle is short during use, a relatively high critical pressure may be set. In some embodiments, in a secondary battery manufactured with a material and/or design having relatively high heat-resistance and/or pressure-resistance, a relatively high critical pressure may be set. Conversely, in a secondary battery manufactured with a material and/or design having relatively low heat-resistance and/or pressure-resistance, a relatively low critical pressure may be set. Additionally or alternatively, the vent may be configured to open when an internal temperature exceeds a predetermined critical temperature. Through this configuration, the vent may prevent explosion of the secondary battery 100 or prevent a chain thermal runaway reaction of secondary batteries arranged close to the secondary battery 100.

In some embodiments, the secondary battery 100 may include a sealer 150 that seals a through-hole (for example, the electrolyte injection port 126 or a vent) formed on at least one surface of the case 140. FIGS. 1 and 2 illustrate the sealer 150 attached on the electrolyte injection port 126; however, the present disclosure is not limited thereto. The sealer 150 may be attached on a through-hole that penetrates the case 140, such as the vent, so as to seal the through-hole.

In some embodiments, the sealer 150 may include a self-restoring material. The sealer 150 may be configured such that a deformed geometry of the sealer 150 caused as gas generated inside the case 140 passes through the sealer 150 is restored. Specifically, due to characteristics of the self-restoring material such as viscosity, an original geometry of the sealer 150 may be restored even if fluid (e.g., gas) passes through the material. The self-restoring material may include at least one selected from the group consisting of isotactic polypropylene, polyvinyl chloride, polyurethane, polyrotaxane, polyester, epoxy resin, and acrylic ester.

In some embodiments, the case body 120 may include an accommodating portion and a flange 128. Specifically, an accommodating portion that accommodates the electrode assembly 110 may be formed in an approximately central region of the case body 120 by press working. In addition, a flange 128 that extends outward from an end of the open accommodating portion may be formed. The flange 128 may be formed in four directions at an upper edge of the accommodating portion.

In some embodiments, the case body 120 and the cover 130 may be joined to form an exterior of the secondary battery 100. The case body 120 and the cover 130 may be joined by metal bonding (for example, welding, brazing, or soldering). The flange 128 of the case body 120 and an edge of the cover 130 may be joined. After the case body 120 and the cover 130 are joined, at least a portion of the flange 128 may be cut using a laser to improve an energy density of the secondary battery 100.

The secondary battery 100 may be a lithium battery cell or a sodium battery cell. However, the present disclosure is not limited thereto, and the secondary battery 100 may include any battery capable of repeatedly supplying electricity via charging and discharging. In some embodiments, when the secondary battery 100 is a lithium battery cell, excellent lifetime characteristics and high-rate characteristics may allow the secondary battery to be used in an electric vehicle (EV). The lithium battery cell may be used in a hybrid vehicle such as a plug-in hybrid electric vehicle (PHEV). In addition, a lithium battery cell may be used in fields that require large-capacity power storage. The lithium battery cell may be used in an electric bicycle or a power tool.

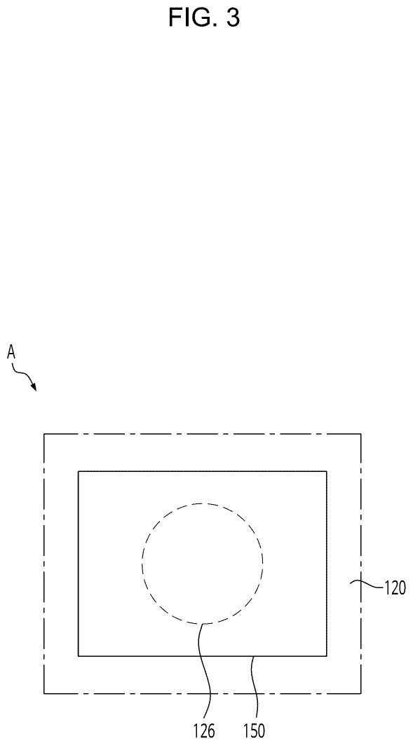

FIG. 3 illustrates an enlarged view of a partial area A of a secondary battery according to some embodiments of the present disclosure. FIG. 3 illustrates an enlarged view of a partial area A of one surface of the case body 120. The partial area A may include the electrolyte injection port 126 and the sealer 150 covering the electrolyte injection port 126.

The sealer 150 may have a rectangular geometry. However, the sealer 150 is not limited thereto and may have various geometries capable of covering the through-hole. The sealer 150 may have geometries such as a polygon, a circle, or an ellipse. In addition, an area of a geometry of the sealer 150 may be greater than an area of a geometry the through-hole in order to seal the through-hole.

The sealer 150 may include an adhesive layer between the sealer 150 and the case so that the sealer 150 is attached to the case. The adhesive layer may be disposed on at least a portion of one surface of the sealer 150, and that surface may be attached to the case. The adhesive layer may be attached to the case such that the sealer 150 covers the through-hole.

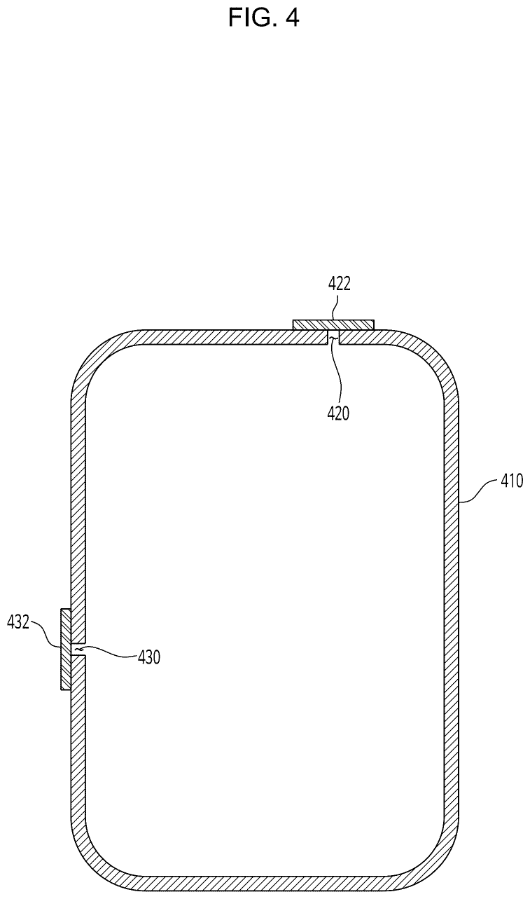

FIG. 4 illustrates a case 410 to which a sealer is coupled according to some embodiments of the present disclosure. In some embodiments, an electrolyte injection port 420, being a through-hole, may be formed on one surface of the case 410. In addition, a vent 430, being another through-hole, may be formed on one surface of the case 410. Referring to FIG. 4, the surface of the case 410 where the electrolyte injection port 420 is formed and the surface of the case 410 where the vent 430 is formed are illustrated as being different, but the present disclosure is not limited thereto.

In some embodiments, a first sealer 422 may seal the electrolyte injection port 420. The first sealer 422 may cover the electrolyte injection port 420 from an outer side of the case 410. After electrolyte is injected through the electrolyte injection port 420, the first sealer 422 may be attached to the case 410 from the outer side of the case 410.

In some embodiments, a second sealer 432 may seal the vent 430. The second sealer 432 may cover the vent 430 from an outer side of the case 410. When an internal pressure of the case 410 reaches a first critical pressure, the vent 430 may be configured to open. The second sealer 432 may be configured so that gas is discharged at a second critical pressure that is less than the first critical pressure, so that gas inside the case 410 may be smoothly discharged. Alternatively, the second sealer 432 may be configured so that gas is discharged at a third critical pressure that is greater than the first critical pressure, thereby doubly performing a function of the vent 430.

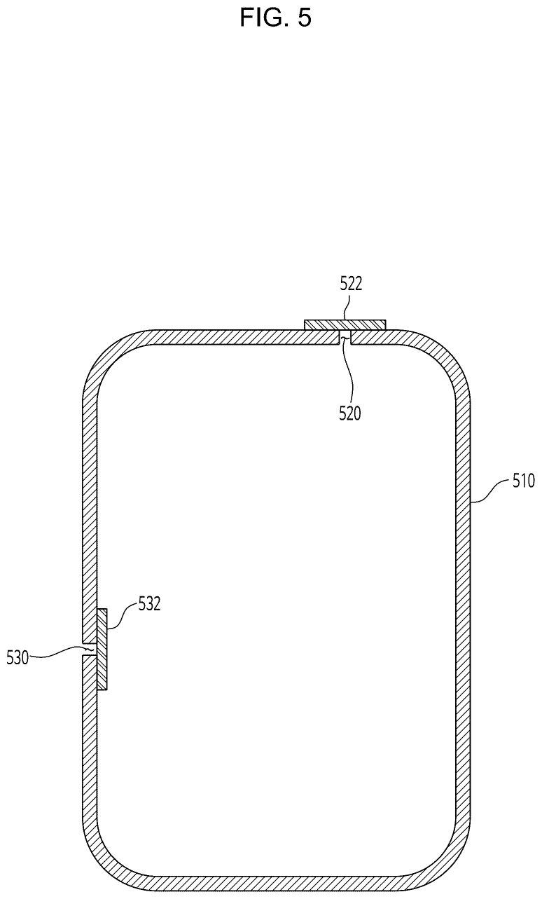

FIG. 5 illustrates a case 510 to which a sealer is coupled according to some embodiments of the present disclosure. In some embodiments, an electrolyte injection port 520 as a through-hole may be formed on one surface of the case 510. In addition, a vent 530 as another through-hole may be formed on one surface of the case 510.

In some embodiments, a first sealer 522 may seal the electrolyte injection port 520. The first sealer 522 may cover the electrolyte injection port 520 from an outer side of the case 510. However, the first sealer 522 is not limited thereto and may cover the electrolyte injection port 520 from an inner side of the case 510. An electrolyte injection device such as a needle may be inserted so as to penetrate the electrolyte injection port 520 and the first sealer 522. An electrolyte may be injected into the case 510 via the electrolyte injection device. After the electrolyte injection device is separated from the case 510, a deformed geometry of the first sealer 522 caused by the electrolyte injection device may be restored to an original geometry of the first sealer 522. The restored first sealer 522 may reseal the electrolyte injection port 520.

In some embodiments, a second sealer 532 may seal the vent 530. The second sealer 532 may cover the vent 530 from an outer side of the case 510. When an internal pressure of the case 510 reaches a first critical pressure, the vent 530 may be configured to open. The second sealer 532 may be configured so that gas is discharged at a second critical pressure less than the first critical pressure. Alternatively, the second sealer 532 may be configured so that gas is discharged at a third critical pressure greater than the first critical pressure. The second sealer 532 may doubly perform a function of the vent 530.

As described above, a plurality of through-holes may be formed in the case 510, and the sealers 522 and 532 may seal at least some of the plurality of through-holes respectively.

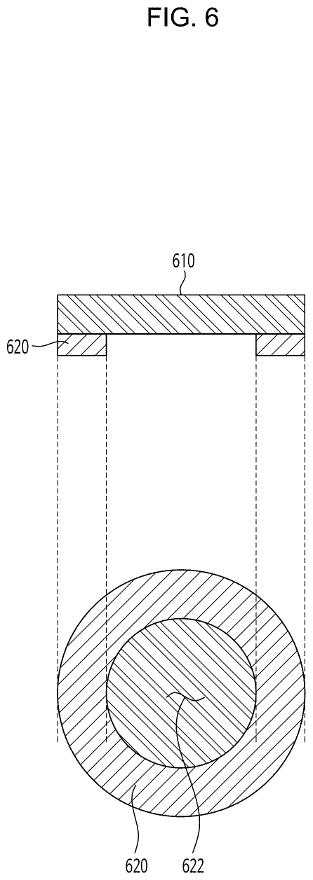

FIG. 6 illustrates a sealer 610 and an adhesive layer 620 according to some embodiments of the present disclosure. In some embodiments, the adhesive layer 620 may be disposed on one surface of the sealer 610. The adhesive layer 620 may be attached to a case of the secondary battery and may couple the sealer 610 and the case.

In some embodiments, the adhesive layer 620 may include a through-portion 622 in which a central region is penetrated. A diameter of the through-portion 622 may be greater than a diameter of a through-hole of the case. The adhesive layer 620 may include a resin capable of metal adhesion. The resin capable of metal adhesion may include a polyolefin resin, a polyurethane resin, and/or an epoxy resin.

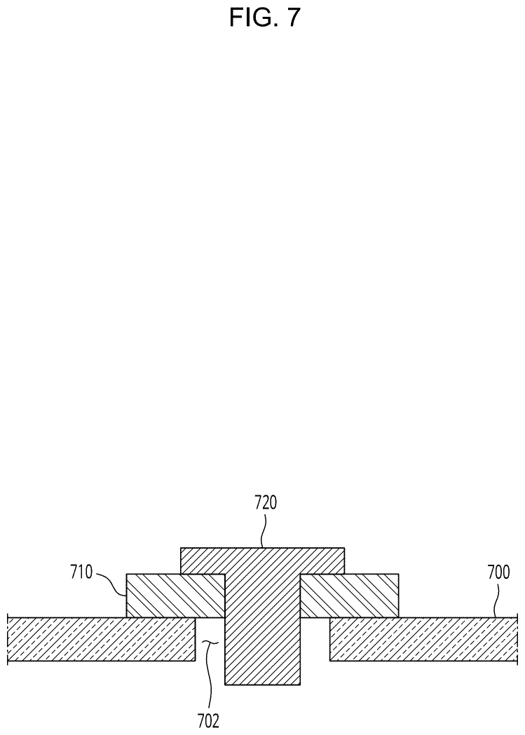

FIG. 7 illustrates a sealer 710 and a rivet portion 720 according to some embodiments of the present disclosure. In some embodiments, the sealer 710 may be disposed on a through-hole 702 of a case 700. The rivet portion 720 may penetrate the sealer 710 and may be inserted into the through-hole 702. Gas inside the case 700 may flow through (or penetrate) the sealer 710 via a region exposed to the through-hole 702.

In some embodiments, the rivet portion 720 may be electrically connected to an electrode tab (for example, a positive-electrode tab or a negative-electrode tab) of the electrode assembly inside the case 700. The rivet portion 720 may be electrically connected to an external terminal and may function as an electrode terminal.

In some embodiments, the sealer 710 may include an adhesive material. Therefore, the sealer 710 may be attached to the case 700. In addition, the rivet portion 720 may be inserted into and coupled to the sealer 710.

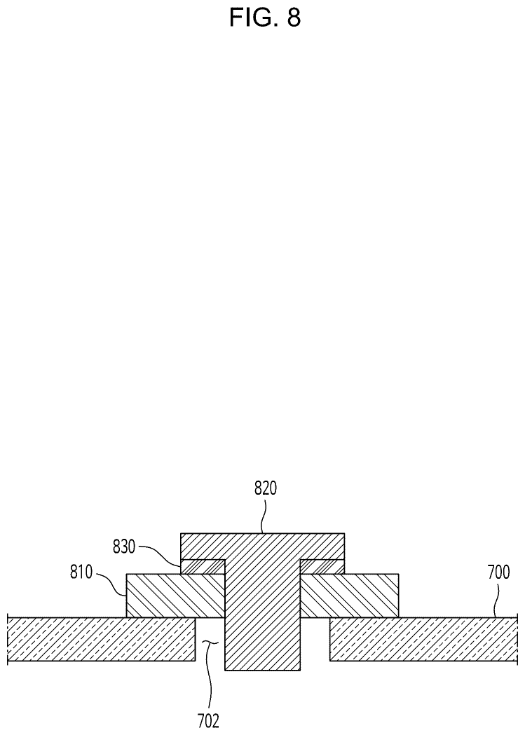

FIG. 8 illustrates a sealer 810 and a rivet portion 820 according to some embodiments of the present disclosure. Except for an adhesive layer 830 disposed between the sealer 810 and the rivet portion 820, the sealer 810 and the rivet portion 820 described with reference to FIG. 8 may be substantially identical to the sealer 710 and the rivet portion 720 described with reference to FIG. 7.

The adhesive layer 830 may be disposed between the rivet portion 820 and the sealer 810. The adhesive layer 830 may include a resin capable of rapid adhesion. A resin capable of metal adhesion may include a polyolefin resin, a polyurethane resin, and/or an epoxy resin. Accordingly, the adhesive layer 830 may couple the rivet portion 820 and the sealer 810.

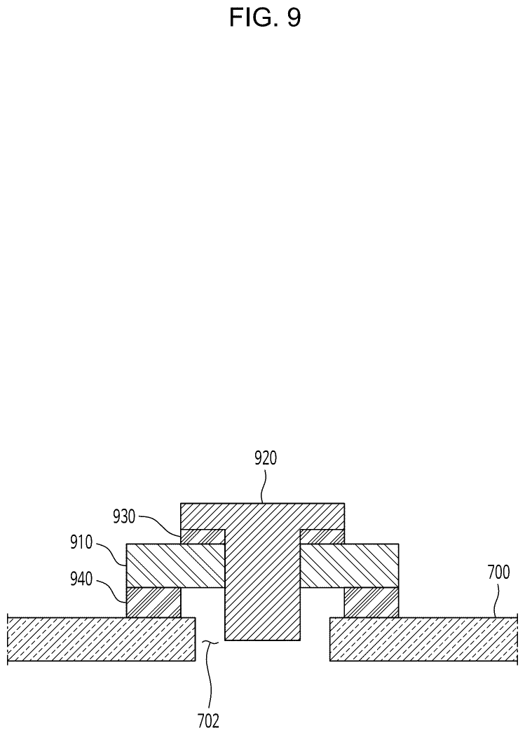

FIG. 9 illustrates a sealer 910 and a rivet portion 920 according to some embodiments of the present disclosure. In some embodiments, a first adhesive layer 940 may be disposed between the sealer 910 and a case 700. In addition, a second adhesive layer 930 may be disposed between the sealer 910 and the rivet portion 920. Except for the first adhesive layer 940 disposed between the sealer 910 and the case 700, the sealer 910, the rivet portion 920, and the second adhesive layer 930 described with reference to FIG. 9 may be substantially identical to the sealer 810, the rivet portion 820, and the adhesive layer 830 described with reference to FIG. 8.

In some embodiments, the first adhesive layer 940 may include a through-portion in which a central region is penetrated. A diameter of the through-portion may be greater than a diameter of a through-hole of the case. The first adhesive layer 940 may include a resin capable of metal adhesion. The resin capable of metal adhesion may include a polyolefin resin, a polyurethane resin, and/or an epoxy resin. Accordingly, the first adhesive layer 940 may couple the sealer 910 and the case 700.

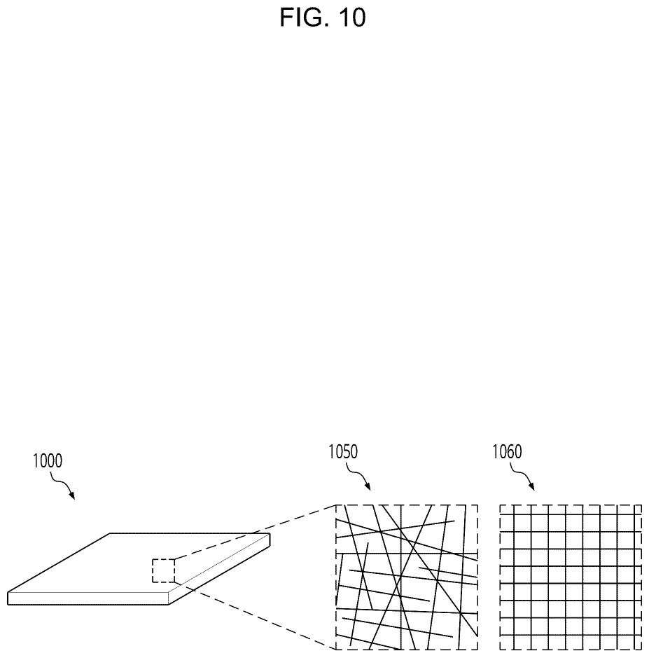

FIG. 10 illustrates a porous film 1000 according to some embodiments of the present disclosure. In some embodiments, the sealer may include the porous film 1000 having a mesh structure. Referring to a first example 1050, the porous film 1000 may have a non-woven-fabric structure having an irregular pattern. Referring to a second example 1060, the porous film 1000 may have a woven-fabric structure having a regular pattern.

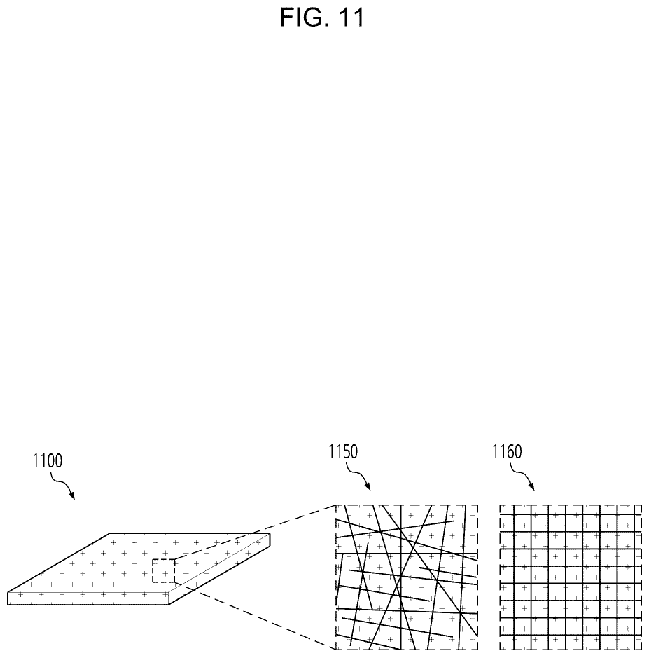

FIG. 11 illustrates a sealer 1100 according to some embodiments of the present disclosure. In some embodiments, the sealer may include the porous film 1000 of FIG. 10 and a self-restoring (or self-recovery) material. Specifically, by applying the self-restoring material melted into the porous film, the self-restoring material may be impregnated into the porous film.

In some embodiments, at least a portion of the self-restoring material may be located inside pores of the porous film. A structure of the porous film may be a framework of the sealer, and the self-restoring material may be located between the frameworks. Gas may accordingly pass through the self-restoring material.

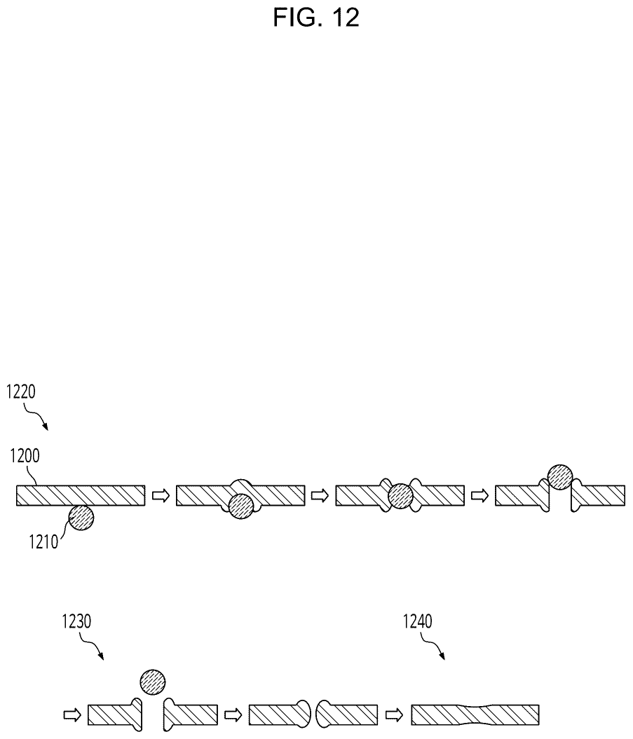

FIG. 12 illustrates a process in which gas is discharged through a sealer 1200 according to some embodiments of the present disclosure. In some embodiments, gas 1210 may be generated inside a case. The gas 1210 may pass through an interior of the sealer 1200, and, as the gas 1210 moves from inside the case toward the outside, the sealer 1200 may be deformed. Thereafter, the sealer 1200 may restore the deformed geometry due to properties (e.g., viscosity) of the self-restoring material. The deformed geometry may be restored to an original state by movement of molecules contained in the self-restoring material.

The sealer 1200 may have a first state 1220, which is a geometry before an external force is applied. Subsequently, the sealer 1200 may have a second state 1230, which is a deformed geometry as the gas 1210 passes through the sealer 1200. After the gas 1210 passes through the sealer 1200 and is discharged to the outside of the case, the sealer 1200 may have a third state 1240, which is a restored geometry. A geometry of the third state 1240 may be substantially identical or similar to a geometry of the first state 1220.

In some embodiments, the sealer 1200 may further include an inorganic filler having heat-resistant characteristics. The inorganic filler may include an alkaline-earth-metal oxide, calcium carbonate, glass fiber, carbon fiber, and/or silicon carbide. The sealer 1200 may adjust thermal influences of the sealer 1200 according to a content of the inorganic filler. As a content of the inorganic filler of the sealer 1200 increases, resistance against thermal runaway of the secondary battery may become strong. In some embodiments, as the content of the inorganic filler of the sealer 1200 decreases, heat and/or gas discharge through the sealer 1200, which becomes sensitive to ambient heat, may increase.

In some embodiments, the sealer 1200 may further include a low-water-vapor-permeability resin that reduces an amount of gas flowing through the sealer 1200. The low-water-vapor-permeability resin may include a fluorosilane, PTFE (polytetrafluoroethylene), PCTFE (polychlorotrifluoroethylene), EVOH (ethylene-vinyl alcohol), PVdC (polyvinylidene chloride), and/or nylon. An amount of gas (for example, water vapor generated as electrolyte vaporizes) moving through the sealer 1200 may be adjusted according to a content of the low-water-vapor-permeability resin in the sealer 1200. As a content of the low-water-vapor-permeability resin in the sealer 1200 increases, gas discharge through the sealer 1200 may increase. Accordingly, even when an internal pressure of the case is relatively low, gas may be discharged through the sealer 1200. In some embodiments, as the content of the low-water-vapor-permeability resin in the sealer 1200 decreases, gas discharge through the sealer 1200 may decrease or stay the same. Accordingly, gas may be discharged through the sealer 1200 when an internal pressure of the case reaches a relatively high pressure.

In some embodiments, as a thickness of the sealer 1200 increases, gas permeability may decrease. In addition, as temperature increases, gas permeability of the sealer 1200 may increase. By adjusting the thickness of the sealer 1200 or adjusting a temperature of an environment to which a secondary battery including the sealer 1200 is exposed, gas permeability of the sealer 1200 may be adjusted.

Tables 1-12 below present experimental data on gas permeability of the sealer using a secondary battery that includes the sealer. The sealer seals the electrolyte injection port of the secondary battery. A diameter of the electrolyte injection port is about 2 mm, the sealer has a circular geometry, and the diameter is about 3 mm. Unless specifically mentioned, a thickness of the sealer is about 50 μm.

TABLE 1

| | | | | Gas- | | Voltage- |
|---|---|---|---|---|---|---|
| | Contained | Test | Burst | permeation | Recovery | retention |
| | material | temperature | pressure | amount | time | ratio |
| Comparative | PP | Room | 0.45 | X | X | 100 |
| Example 1 | | temperature | | | | |
| Comparative | PP | 80 | 0.29 | 6 | X | 98.0 |
| Example 2 | | | | | | |
| Comparative | PP | 130 | 0.16 | 2430 | X | 5.7 |
| Example 3 | | | | | | |

First, gas permeability was tested using a secondary battery that includes a sealer made of PP (polypropylene). A test temperature indicates a temperature of an environment in which the secondary battery is placed and is expressed in degrees Celsius. Room temperature indicates from about 20° C. to about 25° C. Burst pressure indicates a pressure at which the sealer is separated from the secondary battery while a device that injects gas into the secondary battery is connected, and the unit is MPa. After the secondary battery reaches the test temperature, gas is injected into the secondary battery to measure the burst pressure.

Gas-permeation amount indicates a weight change amount of the secondary battery, obtained by measuring a weight of the secondary battery at predetermined times after the secondary battery reaches the test temperature, and the units of gas-permeation is mg/h. A minimum detection amount of the gas-permeation amount is 0.1 mg/h. Five minutes after the secondary battery reaches the test temperature, internal pressures of the secondary battery were measured as below detection limit at room temperature, about 16 kPa at 80° C., and about 650 kPa at 130° C. Recovery time is a time, in minutes, required for an internal pressure of the secondary battery to become about 100 mbar or less after the secondary battery is left at the test temperature for about 1 hour. When the recovery time is “X,” the recovery time indicates that the internal pressure of the secondary battery continuously remains greater or continuously remains less than about 100 mbar. Voltage-retention ratio is expressed as a percentage obtained by dividing a voltage of the secondary battery after the test by a voltage of the secondary battery before the test. Experiments for identifying burst pressure and experiments for identifying gas-permeation amount and voltage-retention ratio were separately conducted.

Comparative Examples 1-3 are secondary batteries that include a sealer sealing an electrolyte injection port of the secondary battery, and the sealers of Comparative Examples 1-3 include PP rather than a self-restoring material. In Comparative Examples 1-3, it can be confirmed that voltage-retention ratio is low after gas is discharged through the sealer at high temperature. Comparative Examples 1-3 cannot be reused after gas is discharged from the secondary battery.

TABLE 2

| | Self- | | | Gas- | | Voltage- |
|---|---|---|---|---|---|---|
| | restoring | Test | Burst | permeation | Recovery | retention |
| | material | temperature | pressure | amount | time | ratio |
| Example 1 | iso-PP | Room | 0.45 | X | X | 100 |
| | | temperature | | | | |
| Example 2 | iso-PP | 80 | 0.29 | 6 | X | 97.8 |
| Example 3 | iso-PP | 130 | 0.16 | 450 | 30 | 70.5 |

TABLE 3

| | Self- | | | Gas- | | Voltage- |
|---|---|---|---|---|---|---|
| | restoring | Test | Burst | permeation | Recovery | retention |
| | material | temperature | pressure | amount | time | ratio |
| Example 4 | PVC | Room | 0.32 | X | X | 100 |
| | | temperature | | | | |
| Example 5 | PVC | 80 | 0.19 | 22 | X | 96.1 |
| Example 6 | PVC | 130 | 0.09 | 810 | 26 | 68.3 |

TABLE 4

| | Self- | | | Gas- | | Voltage- |
|---|---|---|---|---|---|---|
| | restoring | Test | Burst | permeation | Recovery | retention |
| | material | temperature | pressure | amount | time | ratio |
| Example 7 | PU | Room | 0.37 | X | X | 100 |
| | | temperature | | | | |
| Example 8 | PU | 80 | 0.27 | 19 | X | 95.9 |
| Example 9 | PU | 130 | 0.09 | 720 | 25 | 68.8 |

TABLE 5

| | Self- | | | Gas- | | Voltage- |
|---|---|---|---|---|---|---|
| | restoring | Test | Burst | permeation | Recovery | retention |
| | material | temperature | pressure | amount | time | ratio |
| Example | Polyrotaxane | Room | 0.41 | X | X | 100 |
| 10 | | temperature | | | | |
| Example | Polyrotaxane | 80 | 0.20 | 8 | X | 96.4 |
| 11 | | | | | | |
| Example | Polyrotaxane | 130 | 0.10 | 550 | 24 | 68.9 |
| 12 | | | | | | |

TABLE 6

| | Self- | | | Gas- | | Voltage- |
|---|---|---|---|---|---|---|
| | restoring | Test | Burst | permeation | Recovery | retention |
| | material | temperature | pressure | amount | time | ratio |
| Example 13 | Polyester | Room | 0.30 | X | X | 100 |
| | | temperature | | | | |
| Example 14 | Polyester | 80 | 0.15 | 14 | X | 96.2 |
| Example 15 | Polyester | 130 | 0.10 | 490 | 35 | 69.3 |

TABLE 7

| | Self- | | | Gas- | | Voltage- |
|---|---|---|---|---|---|---|
| | restoring | Test | Burst | permeation | Recovery | retention |
| | material | temperature | pressure | amount | time | ratio |
| Example 16 | Epoxy | Room | 0.56 | X | X | 100 |
| | resin | temperature | | | | |
| Example 17 | Epoxy | 80 | 0.38 | 12 | X | 96.2 |
| | resin | | | | | |
| Example 18 | Epoxy | 130 | 0.19 | 490 | 40 | 69.5 |
| | resin | | | | | |

TABLE 8

| | Self- | | | Gas- | | Voltage- |
|---|---|---|---|---|---|---|
| | restoring | Test | Burst | permeation | Recovery | retention |
| | material | temperature | pressure | amount | time | ratio |
| Example 19 | Acrylic | Room | 0.50 | X | X | 100 |
| | ester | temperature | | | | |
| Example 20 | Acrylic | 80 | 0.26 | 20 | X | 96.0 |
| | ester | | | | | |
| Example 21 | Acrylic | 130 | 0.08 | 670 | 21 | 68.2 |
| | ester | | | | | |

Examples 1-21 present experimental data according to kinds of self-restoring materials contained in the sealer. The sealers of Examples 1-3 include iso-PP, the sealers of Examples 4-6 include PVC (polyvinyl chloride), and the sealers of Examples 7-9 include PU (polyurethane). Other experimental methods are identical to those of Comparative Examples 1-3.

From Examples 1-21, it was confirmed that the sealers of Examples 1-21 did not have an external-geometry deformation at 80° C. and that only gas permeation occurred; whereas, at 130° C., an external-geometry deformation occurred, and gas was discharged. Subsequently, after a predetermined period of time, geometries of the sealers of Examples 1-21 were restored. Voltage-retention ratios of Examples 1-21 are around 70%, so the secondary battery may be reused even after gas is discharged at a high temperature.

TABLE 9

| | | | | | Gas- | | Voltage- |
|---|---|---|---|---|---|---|---|
| | Porous | | Test | Burst | permeation | Recovery | retention |
| | film | Thickness | temperature | pressure | amount | time | ratio |
| Example | Non- | 50 | Room | 0.4 | X | X | 100 |
| 22 | woven | | temperature | | | | |
| | fabric | | | | | | |
| Example | Non- | 50 | 80 | 0.31 | 2 | X | 98.3 |
| 23 | woven | | | | | | |
| | fabric | | | | | | |
| Example | Non- | 50 | 130 | 0.18 | 440 | 30 | 70.7 |
| 24 | woven | | | | | | |
| | fabric | | | | | | |

TABLE 10

| | | | | | Gas- | | Voltage- |
|---|---|---|---|---|---|---|---|
| | Porous | | Test | Burst | permeation | Recovery | retention |
| | film | Thickness | temperature | pressure | amount | time | ratio |
| Example | Non- | 25 | Room | 0.44 | X | X | 100 |
| 25 | woven | | temperature | | | | |
| | fabric | | | | | | |
| Example | Non- | 25 | 80 | 0.29 | 5 | X | 97.7 |
| 26 | woven | | | | | | |
| | fabric | | | | | | |
| Example | Non- | 25 | 130 | 0.16 | 670 | 27 | 69.8 |
| 27 | woven | | | | | | |
| | fabric | | | | | | |

TABLE 11

| | | | | | Gas- | | Voltage- |
|---|---|---|---|---|---|---|---|
| | Porous | | Test | Burst | permeation | Recovery | retention |
| | film | Thickness | temperature | pressure | amount | time | ratio |
| Example | Non- | 75 | Room | 0.4 | X | X | 100 |
| 28 | woven | | temperature | | | | |
| | fabric | | | | | | |
| Example | Non- | 75 | 80 | 0.32 | 2 | X | 98.2 |
| 29 | woven | | | | | | |
| | fabric | | | | | | |
| Example | Non- | 75 | 130 | 0.20 | 390 | 33 | 71.0 |
| 30 | woven | | | | | | |
| | fabric | | | | | | |

TABLE 12

| | | | | | Gas- | | Voltage- |
|---|---|---|---|---|---|---|---|
| | Porous | | Test | Burst | permeation | Recovery | retention |
| | film | Thickness | temperature | pressure | amount | time | ratio |
| Example | Woven | 50 | Room | 0.45 | X | X | 100 |
| 31 | fabric | | temperature | | | | |
| Example | Woven | 50 | 80 | 0.33 | 2 | X | 98.2 |
| 32 | fabric | | | | | | |
| Example | Woven | 50 | 130 | 0.20 | 460 | 30 | 70.5 |
| 33 | fabric | | | | | | |

The sealers of Examples 1-21 are formed by molding the self-restoring material into a film rather than by including a porous film. The sealers of Examples 22-33 are obtained by impregnating iso-PP, which is a self-restoring material, into the porous film as described above with reference to FIG. 11. The sealers of Examples 22-30 include a porous film having a non-woven-fabric structure with an irregular pattern. The sealers of Examples 31-33 include a porous film having a woven-fabric structure with a regular pattern. The porous film includes PET (polyethylene terephthalate). From the experimental results of Examples 22-33, it can be confirmed that, even when the sealer includes the porous film, voltage-retention ratios of the secondary batteries of the Examples are around 70%, and, therefore, the secondary batteries can be reused.

A thickness of each sealer of Examples 1-21 is about 50 μm. The sealers of Examples 25-27 have a thickness of about 25 μm, and the sealers of Examples 28-30 have a thickness of about 75 μm. As the thickness of the sealer increases, gas-permeation amount at high temperature increases, and the voltage-retention ratio of the secondary battery of the corresponding example increases. As the thickness of the sealer increases, reuse of the secondary battery becomes easier.

As described above, even when a geometry of the sealer 1200 is deformed as gas is discharged, the geometry of the sealer 1200 may be restored, and the sealer 1200 may seal the through-hole of the case again. By sealing the through-hole of the case with the sealer including the self-restoring material, the secondary battery may be reused. Accordingly, even if gas is discharged from the secondary battery exposed to a high-temperature and/or high-pressure environment, the secondary battery may be stabilized again. Further, the secondary battery, when stabilized, may be safely reused. The secondary battery according to some embodiments may reduce costs of manufacture and/or production and may contribute to environmental preservation because the secondary battery may be recyclable.

In addition, by adjusting contents of the self-restoring material, inorganic filler, and/or low-water-vapor-permeability resin, the sealer 1200 may be manufactured so that gas inside the case is easily discharged or so that gas inside the case is less easily discharged. Therefore, the sealer 1200 may be manufactured to meet conditions corresponding to various secondary-battery designs and environments.

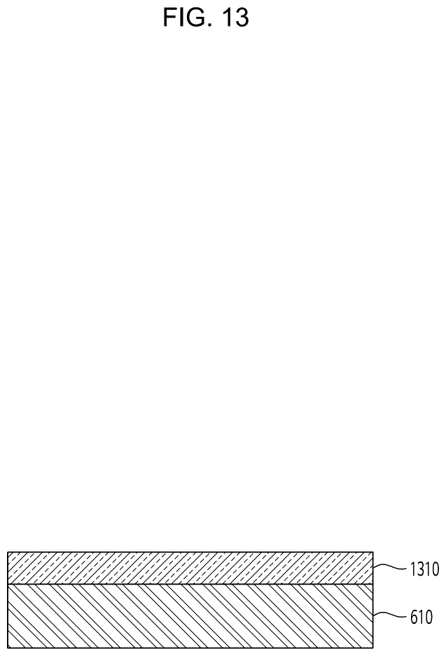

FIG. 13 illustrates a sealer 610 and a functional layer 1310 according to some embodiments of the present disclosure. In some embodiments, the functional layer 1310 may be disposed on one surface of the sealer 610. Further, in some embodiments, another surface opposite to the one surface of the sealer 610 may face a case of a secondary battery. Gas generated inside the case may flow in a direction passing through the sealer 610 and then through the functional layer 1310.

In some embodiments, the functional layer 1310 may include a low-water-vapor-permeability resin that reduces an amount of gas (for example, gas including water vapor generated as an electrolyte vaporizes) flowing through the functional layer 1310. The low-water-vapor-permeability resin may include a fluorine sealant, PTFE (polytetrafluoroethylene), PCTFE (polychlorotrifluoroethylene), EVOH (ethylene vinyl alcohol), PVdC (polyvinylidene chloride), and/or nylon.

In some embodiments, an amount of gas moving through the functional layer 1310 may be adjusted according to a content of the low-water-vapor-permeability resin in the functional layer 1310. As a content of the low-water-vapor-permeability resin in the functional layer 1310 increases, gas discharge through the functional layer 1310 may increase. In some embodiments, as a thickness of the functional layer 1310 decreases, gas discharge through the functional layer 1310 may increase. Accordingly, even when an internal pressure of the case is relatively low, gas may be discharged through the sealer 610 and the functional layer 1310.

Tables 13 and 14 below present experimental data on gas permeability of the sealer and functional layer using a secondary battery that includes the sealer and functional layer. Examples 34-39 correspond to some embodiments in which the functional layer is disposed on one surface of the sealers of above-described Examples 1-3. Experimental conditions are substantially identical to those of Examples 1-3 described above.

TABLE 13

| | Material of | | | | Gas- | | Voltage- |
|---|---|---|---|---|---|---|---|
| | functional | | Test | Burst | permeation | Recovery | retention |
| | layer | Thickness | temperature | pressure | amount | time | ratio |
| Example | MAPP | 15 | Room | 0.52 | X | X | 100 |
| 34 | | | temperature | | | | |
| Example | MAPP | 15 | 80 | 0.32 | 2 | X | 98.1 |
| 35 | | | | | | | |
| Example | MAPP | 15 | 130 | 0.21 | 340 | 30 | 71.2 |
| 36 | | | | | | | |

TABLE 14

| | Material of | | | | Gas- | | Voltage- |
|---|---|---|---|---|---|---|---|
| | functional | | Test | Burst | permeation | Recovery | retention |
| | layer | Thickness | temperature | pressure | amount | time | ratio |
| Example | PP | 15 | Room | 0.55 | X | X | 100 |
| 37 | | | temperature | | | | |
| Example | PP | 15 | 80 | 0.36 | 2 | X | 98.1 |
| 38 | | | | | | | |
| Example | PP | 15 | 130 | 0.24 | 320 | 32 | 71.4 |
| 39 | | | | | | | |

Examples 34-39 present experimental data according to kinds of materials contained in the functional layer. The functional layers of Examples 34-36 include MAPP (maleic acid modified polypropylene), and those of Examples 37-39 include PP. A thickness of each functional layer of Examples 34-39 is about 15 μm.

From Examples 34-39, it can be confirmed that the voltage-retention ratio slightly increases compared with Examples 1-33. By using the functional layers of Examples 34-39, performance of a reused secondary battery may be relatively improved.

Although the present disclosure has been described above with respect to some embodiments thereof, the present disclosure is not limited thereto. Various modifications and variations can be made to embodiments of the present disclosure by those skilled in the art.

### DESCRIPTION OF REPRESENTATIVE REFERENCE NUMERALS

100: secondary battery
110: electrode assembly
112: positive-electrode tab
114: negative-electrode tab
120: case body
122: positive-terminal
124: negative-terminal
126: electrolyte injection port
128: flange
130: cover
140: case
150: sealer

What is claimed is:

1. An assembly for a secondary battery, the assembly comprising:
a case; and
a sealer comprising a self-restoring material, wherein the sealer seals a through-hole formed in the case.

2. The assembly as claimed in claim 1, wherein the self-restoring material has a viscosity allowing movement of molecules contained in the self-restoring material such that a deformed geometry of the sealer recovers after a gas generated inside the case passes through the sealer.

3. The assembly as claimed in claim 1, wherein the self-restoring material comprises isotactic polypropylene, polyvinyl chloride, polyurethane, polyrotaxane, polyester, epoxy resin, or acrylic ester.

4. The assembly as claimed in claim 1, wherein the sealer further comprises a porous film having a mesh structure.

5. The assembly as claimed in claim 4, wherein a portion of the self-restoring material is located within an internal pore of the porous film.

6. The assembly as claimed in claim 1, wherein the sealer further comprises an inorganic filler that is heat-resistant.

7. The assembly as claimed in claim 2, wherein the sealer further comprises a low-water-vapor permeability resin that reduces an amount of the gas flowing through the sealer.

8. A secondary battery comprising:
an electrode assembly;
a case accommodating the electrode assembly, the case having a through-hole on a surface of the case to allow fluid injection or discharge; and
a sealer comprising a self-restoring material, wherein the sealer seals the through-hole of the case.

9. The secondary battery as claimed in claim 8, wherein the through-hole of the case comprises an electrolyte injection port accepting an electrolyte to flow into the case.

10. The secondary battery as claimed in claim 8, wherein the through-hole of the case comprises a vent discharging gas from an inside of the case to an outside of the case.

11. The secondary battery as claimed in claim 8, wherein the sealer seals the through-hole of the case by covering the through-hole of the case from an inner side of the case.

12. The secondary battery as claimed in claim 8, wherein the sealer seals the through-hole of the case by covering the through-hole of the case from an outer side of the case.

13. The secondary battery as claimed in claim 8, wherein an area of a geometry of the sealer is greater than an area of a geometry of the through-hole of the case.

14. The secondary battery as claimed in claim 8, further comprising a first adhesive layer positioned between the case and the sealer.

15. The secondary battery as claimed in claim 14, wherein the first adhesive layer comprises a through-portion penetrating a central region of the first adhesive layer, and
wherein a diameter of the through-portion of the first adhesive layer is greater than a diameter of the through-hole of the case.

16. The secondary battery as claimed in claim 8, further comprising a rivet portion penetrating the sealer and being inserted into the through-hole of the case.

17. The secondary battery as claimed in claim 16, further comprising a second adhesive layer positioned between the rivet portion and the sealer.

18. The secondary battery as claimed in claim 8, wherein the self-restoring material comprises isotactic polypropylene, polyvinyl chloride, polyurethane, polyrotaxane, polyester, epoxy resin, or acrylic ester.

19. The secondary battery as claimed in claim 8, wherein the sealer further comprises a porous film having a mesh structure.

20. A secondary battery comprising:
an electrode assembly;
a case accommodating the electrode assembly, the case having a through-hole formed on a surface of the case to discharge gas from an inside of the case to an outside of the case; and
a sealer sealing the through-hole of the case, the sealer comprising:
a self-restoring material comprising isotactic polypropylene, polyvinyl chloride, polyurethane, polyrotaxane, polyester, epoxy resin, or acrylic ester; and
a porous film having a mesh structure,
wherein the sealer further comprises an inorganic filler that is heat-resistant or a low-water-vapor permeability resin that reduces an amount of gas flowing through the sealer, and
wherein the self-restoring material has a viscosity allowing a movement of molecules contained in the self-restoring material such that a deformed geometry of the sealer recovers after gas generated inside the case passes through the sealer.
